(19) United States
(12) Patent Application Publication
(10) Pub. No.: US 2023/0241732 A1
(43) Pub. Date: Aug. 3, 2023

(54) TOOL CHANGER FOR MACHINE TOOL AND MACHINE TOOL

(71) Applicant: KOMATSU NTC, LTD., Toyama (JP)

(72) Inventor: Akira Kanda, Toyama (JP)

(21) Appl. No.: 18/099,183

(22) Filed: Jan. 19, 2023

(30) Foreign Application Priority Data
Jan. 28, 2022 (JP) 2022-011945

(51) Int. Cl. B23Q 3/155; B23Q 11/08; B23Q 3/157

(52) U.S. Cl. CPC B23Q 3/15539; B23Q 11/08; B23Q 3/15726

(57) ABSTRACT

Provided is a tool changer 2 which includes a first magazine 4, a second magazine 3 arranged rear to the first magazine 4, and a lower wall 61 which partitions a first area A1 and a second area A2, wherein the magazines 3, 4 are provided in the first area A1 and a workpiece is processed in the second area A2. The lower wall 61 includes an opening which communicates the first area A1 with the second area A2. The magazines 3, 4 respectively includes rotatable magazine bodies 31, 41 and a plurality of tool holders 5. The magazine body 31 of the second magazine 3 includes a cut part 33 which is formed by cutting a part of the outer periphery of the magazine body 31. The tool holders 5 are provided in a part of the outer periphery of the magazine bodies 31, 41 other than the cut part. A shutter 7 for opening and closing the opening is provided to a part of the outer periphery of the magazine body 31 of the second magazine 3 other than the cut part.

### CROSS-REFERENCE TO RELATED APPLICATION

This application is based upon and claims priority from the Japanese Patent Application No. 2022-011945, filed on Jan. 28, 2022, the entire contents of which are incorporated herein by reference.

### BACKGROUND OF THE INVENTION

### Field of the Invention

The present application relates to a tool changer for a machine tool and a machine tool.

### Description of the Related Art

Generally, a machine tool including an automatic tool changer is provided with a magazine which holds a plurality of tools used to process a workpiece. The magazine includes a rotatable disk-shaped magazine body and a plurality of tool holders provided to the outer periphery of the magazine body. The machine tool automatically changes the tool attached to the main shaft of the machine tool to an appropriate tool among the plurality of tools held in the magazine and performs a variety of processes on the workpiece continuously.

Japanese Patent Application Publication No. 2014-012307 discloses an automatic tool changer including a partition wall which separates an area where a magazine is provided and an area where a machine tool is moved for processing, wherein an opening is formed in the partition wall. In the automatic tool changer, a shutter which opens and/or closes the opening in accordance with rotation of the magazine is detachably attached to the magazine body (refer to claim 1 in Japanese Patent Application Publication No. 2014-012307).

### SUMMARY OF THE INVENTION

In the tool changer disclosed in Japanese Patent Application Publication No. 2014-012307 tools are changed when the shutter is open, and a workpiece is processed when the shutter is closed so as to prevent chips of the workpiece from being scattered to the side of the magazine. This tool changer makes it possible to automatically move the shutter to the closed position by moving a tool used for the next step to a tool changing position. This configuration also makes it possible to omit a drive unit dedicated to drive the shutter and a sensor for detecting the open/close state of the shutter.

In this tool changer, however, the radius of the magazine body is inevitably made to be larger when many tools, which are to be attached to the main shaft, are held in the tool holders since the tool holders are provided at the outer periphery of the magazine body. Thus, this tool changer has the disadvantage that the size of the tool changer is inevitably made to be larger and an installation space of a machine tool having the large tool changer must be accordingly larger. In addition, this tool changer has another disadvantage that the rotation speed of the magazine is lower since the radius of the magazine body is larger, increasing the time for which the machine tool is not able to process the workpiece. This results in decrease in the productivity of the machine tool.

Possible configuration which is able to solve this problem is that a plurality of magazines are provided in row along the axial direction of the main shaft. However, if the plurality of magazines are respectively provided with a shutter, driving control of the rotation of each of the plurality of magazines must be performed independently to open/close the shutter of the each of the plurality of magazines when a tool is to be changed. Further, when the main shaft comes closer to the tool holders of one of the magazines to change the tool, it is necessary that the main shaft is not interfered with the shutter and the other magazine.

The present invention is made in view of the above problem and an object of the present invention is to provide a tool changer and a machine tool smaller in size and being capable of holding many tools to be attached to a main shaft of the machine tool and of efficiently exchanging tools.

In order to solve the problem, the present invention provides a tool changer for a machine tool for changing a tool attached to the main shaft of the machine tool. The tool changer includes a first magazine which is capable of accommodating the tool, a second magazine which is capable of accommodating the tool, and a partition wall. The second magazine is arranged rear to the first magazine when a distal end side of the main shaft is regarded as a front side and a base end side of the main shaft is regarded as a rear side. The partition wall partitions a first area where the first magazine and the second magazine provided and a second area where a workpiece is processed with the tool attached to the main shaft. The partition wall includes an opening which communicates the first area with the second area. The first magazine and the second magazine each includes a magazine body rotatable about a center axis of the magazine body, the center axis being parallel to an axial direction of the main shaft, and a plurality of tool holders provided to the magazine body. The magazine body of the second magazine includes a cut part which is formed by cutting a part of an outer periphery of the magazine body. The plurality of tool holders is provided to a part of the outer periphery of the magazine body other than the cut part. A shutter for opening or closing the opening is provided to a part of the outer periphery of the magazine body of the second magazine other than the cut part. In addition to this tool changer, the present invention is also a machine tool provided with the tool changer described as above.

The present invention makes it possible to provide a down-sized tool changer for a machine tool and a down-sized machine tool which are capable of accommodating many tools to be attached to a main shaft of the machine tool and are also capable of efficiently exchanging tools.

### BRIEF DESCRIPTION OF DRAWINGS

FIG. 1 is a side view of a machine tool provided with a tool changer according to an embodiment of the present invention.

FIG. 2 is a front view of the tool machine provided with the tool changer shown in FIG. 1.

FIG. 3 is a cross sectional view of the machine tool along the line III-III in FIG. 1.

FIG. 4 is a cross sectional view of the machine tool along the line IV-IV in FIG. 3.

FIG. 5 is a perspective view of the tool changer with the shutter being closed when seen from a forward and upper right oblique side, wherein the tool changer is shown with the cover being partially cut away.

FIG. 6 is a perspective view of the magazine with the shutter being closed when seen from the rearward and lower left oblique side.

FIG. 7 is a cross sectional view of the machine tool shown in FIG. 3 with the shutter being opened.

FIG. 8 is a cross sectional view of the machine tool along the VIII-VIII line in FIG. 7 with the shutter being opened.

FIG. 9 is a perspective view of the tool changer shown in FIG. 5 with the shutter being opened.

FIG. 10 is a front view of a machine tool provided with a tool changer according to another embodiment of the present invention.

### DETAILED DESCRIPTION OF THE EMBODIMENTS

An embodiment of the present invention is descried in detail with reference to the attached drawings. Components common in the drawings are assigned the same reference numerals, and repeated description of those components are omitted as appropriate.

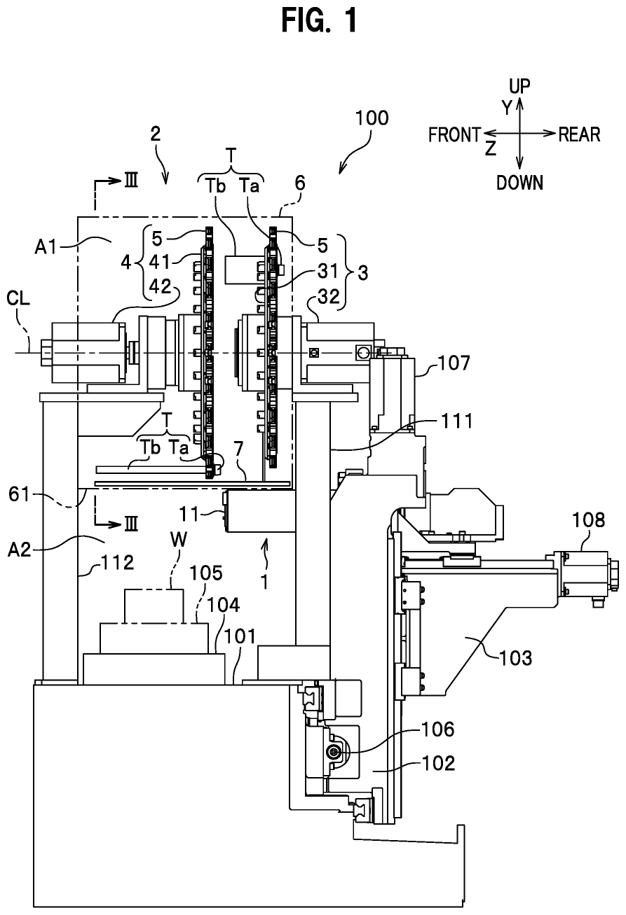

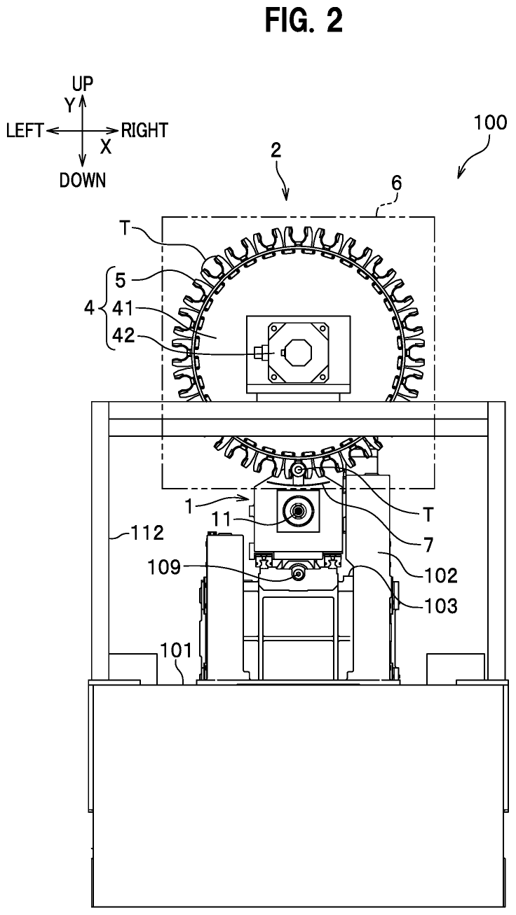

FIG. 1 is a side view of a machine tool 100 which is provided with a tool changer 2 for the machine tool (hereinafter, also referred to as just “a tool changer”) according to the embodiment of the present invention. FIG. 2 is a front view of the machine tool 100 provided with the tool changer 2 shown in FIG. 1. For the convenience of explanation, a side of the distal end of the main shaft 11 is referred to as a front side and a side of the base end of the main shaft 11 is referred to as a rear side. In FIGS. 1 and 2, a direction along the X axis is a right and left direction (a lateral direction), a direction along the Y axis is an up and down direction (a vertical direction), and a direction along the Z axis is a front and rear direction (a depth direction).

As shown in FIGS. 1 and 2, the machine tool 100 according to the present embodiment includes a main shaft 11. The machine tool 100 is a horizontal machine tool in which the main shaft 11 is arranged horizontally.

The machine tool 100 includes a base 101, a column 102, a saddle 103, a main shaft unit 1, a work holding unit 104, a tool changer 2, and a controller (not shown). The main shaft unit 1 includes the main shaft 11 which is rotated by a motor (not shown).

The column 102 is attached to the base 101 in such a manner that the column 102 is slidable in the X axis direction (the right and left direction) with respect to the base 101. The column 102 is slid along the X axis direction by the forward/reverse rotation of the screw shaft 106 driven by a motor (not shown). The saddle 103 is slidable in the Y axis direction (the up and down direction) with respect to the column 102. The saddle 103 is slid along the Y axis direction by the forward/reverse rotation of a screw shaft (not shown) driven by the motor 107. The main shaft unit 1 is attached to the saddle 103 in such a manner that the main shaft unit 1 is slidable along the Z axis direction (the front and rear direction) with respect to the saddle 103. The main shaft unit 1 is slid along the Z direction by the forward/reverse direction of the screw shaft 109 driven by the motor 108 attached to the saddle 103.

The work holding device 104 holds a workpiece W which is to be processed. The work holding device 104 includes a work holder 105 which holds the workpiece W. The work holder 105 is configured to be swingable about an axis which is parallel to the X axis and rotatable about an axis which is parallel to the Y axis.

The machine tool 100 processes the workpiece W with the tool T attached to the distal end of the rotating main shaft 11 in the main shaft unit 1. The tool changer 2 is operated when exchanging the tool T with another tool T. Operation of each unit in the machine tool 100 is integrally controlled by the controller (not shown).

As shown in FIG. 1, the tool T includes a holder Ta to be attached to the main shaft 11 and a cutter Tb fixed to the holder Ta. The tool T is detachably attached to the distal end of the main shaft 11. For the convenience of explanation, only one tool T is shown to be held in the front magazine 4 and the rear magazine 3, respectively, in FIGS. 1 and 2.

The tool changer 2 exchanges the tool T attached to the main shaft 11 of the machine tool 100 as shown in FIGS. 1 and 2. The tool changer 2 in the present embodiment includes two magazines 3 and 4 which are arranged in line in the front rear direction and a cover 6 which covers the magazines 3 and 4. The magazines 3 and 4 are configured to accommodate a plurality of tools T. The magazine 4 is the front magazine (a first magazine) and the magazine 3 is the rear magazine (a second magazine).

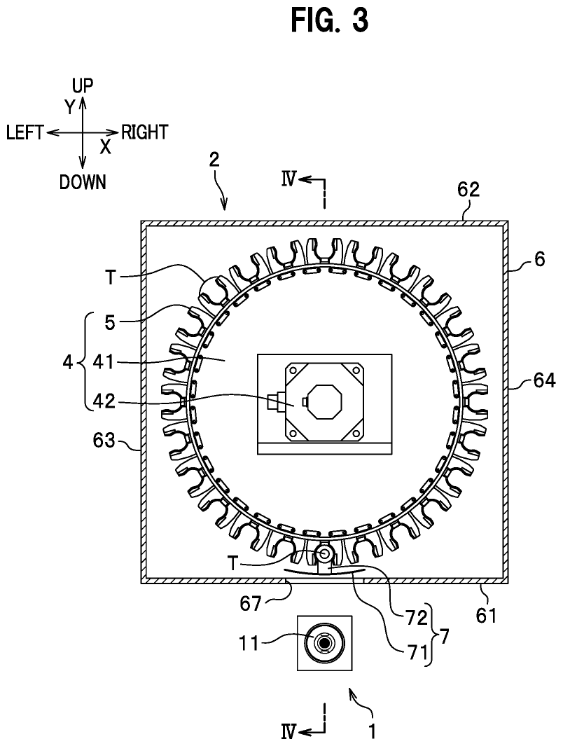

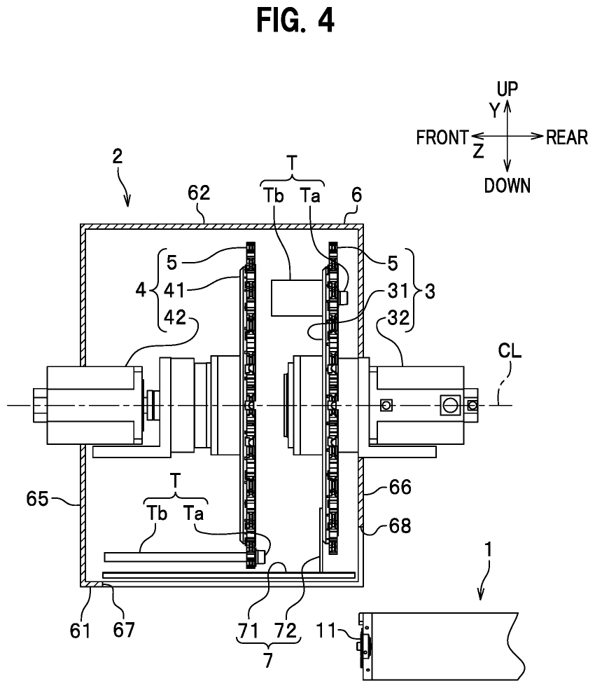

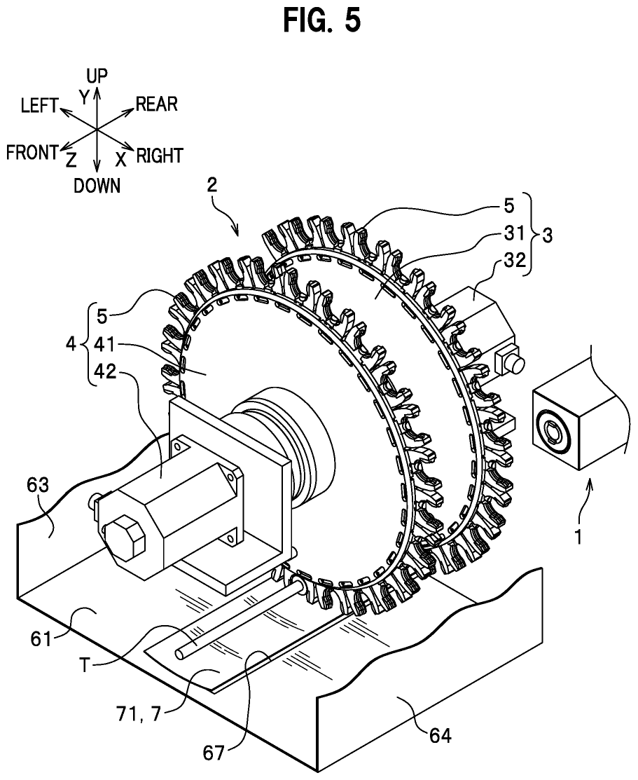

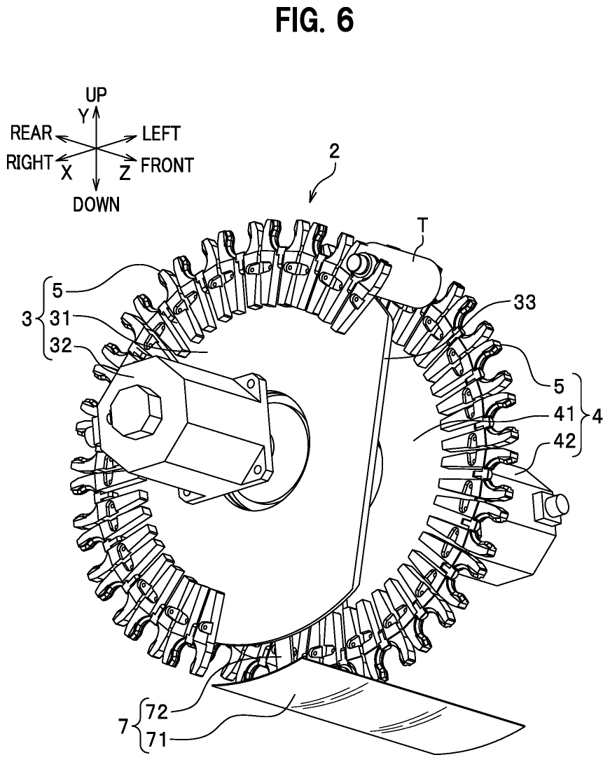

FIG. 3 is a cross sectional view of the machine tool 100 along the III-III line in FIG. 1. FIG. 4 is a cross sectional view of the machine tool 100 along the IV-IV line in FIG. 3. FIG. 5 is a perspective view from the upper and right front oblique side of the tool changer 2 with the shutter 7 being closed wherein the cover 6 is partially cut away. FIG. 6 is a perspective view from the lower and left rear oblique side of the magazines 3 and 4 with the shutter 7 being closed. It is to be noted that components other than the main shaft unit 1 and the tool changer 2 are omitted except for the cover 6, and only the cover 6 is shown in the cross section, in FIGS. 3 and 4. Further, the cover 6 is exaggerated to be thicker in FIGS. 3 and 4.

As shown in FIG. 4, the magazines 3 and 4 respectively includes magazine bodies 31 and 41, a plurality of tool holders 5, and motors 32, 42. The magazine bodies 31 and 41 are plate-like members independently rotatable about the center axis CL which is parallel to the axial direction of the main shaft 11. The magazine bodies 31, 41 in the present embodiment are disc-shaped when seen in the front of the magazine bodies 31, 41.

The tool holders 5 are provided to the magazines bodies 31, 41. Each of the tool holders 5 holds the tool T by sandwiching the holder Ta of the tool T with the elastic force, for example. The motors 32, 42 independently rotate the magazine bodies 31, 41 about the center axis in a desired angle, respectively. As shown in FIG. 1, the motors 32, 42 are fixed to the top surface of the gate-like supports erected on the base 101.

As shown in FIG. 6, the magazine body 31 of the rear magazine 3 includes a cut part 33 which is formed by cutting a part of the outer periphery of the magazine body 31. In the present embodiment, the cut part 33 is a flat part formed by linearly cutting a part of the outer periphery of the magazine body 31. The cut part 33, however, is not limited to this shape. For example, the cut part 33 may be formed to be recessed toward the center of the magazine body 31 by cutting a part of the outer periphery of the magazine body 31 in a recessed shape. The cut part 33 functions as an escape structure, allowing the main shaft 11 to come closer to the front magazine 4 when the tool T is exchanged and to move away from the front magazine 4 after the tool T is exchanged.

In the present embodiment, the tool holders 5 are provided to the outer periphery of the magazine bodies 31, 41 except for the cut part 33. In the present embodiment, fourteen tool holders 5 are provided to the outer periphery of the magazine body 31 of the rear magazine 3 except for the cut part 33 (see FIG. 6), and twenty-four tool holders are provided to the outer periphery of the magazine body 41 of the front magazine 4 (see FIG. 3). The number of tool holders provided to the magazine bodies 31, 41 may vary as appropriate.

As shown in FIG. 4, it is preferable that the center axes of the magazine bodies 31, 41 exist on a straight line and the diameters of circumcircles of the magazine bodies 31, 41 are equal. The magazine bodies 31, 41 are formed to be discotic in the present embodiment, however, the magazine bodies 31, 41 may be formed to be in a multangular shape, for example.

As shown in FIGS. 3 and 5, the cover 6 includes a lower wall, an upper wall 62, a left wall 63, a right wall 64, a front wall and a rear wall 66. The outer shape of the cover 6 is formed to be a rectangular parallelepiped box. The cover 6 is fixed to the support 112, for example. The lower wall 61 functions as a partition wall which separates the first area A1 where the magazines 3, 4 are provided and the second area A2 where the work piece W is processed with the tool T attached to the main shaft 11. Any one of the upper, left, right, front and rear walls except for the lower wall 61 may be omitted.

The lower wall 61 includes an opening 67 which communicates the first area A1 with the second area A2. The opening 67 is, for example, a rectangular hole which extends frontward from the rear end of the lower wall 61. The rear end of the opening 67 opens rearward. Further, the rear wall 66 includes an opening 68 which communicates the first area A1 and an area which is rear to the first area A1 (see FIG. 4). The opening 68 is, for example, a rectangular hole which extends upward from the rear end of the rear wall 66. The rear end of the opening 68 opens downward. Specifically, the openings 67, 68 function as an escape structure, allowing the main shaft 11 to come closer to the magazines 3, 4 when the tool T is changed and to move away from the magazines 3, 4 after the tool T is changed.

The opening 67 of the lower wall 61 is opened or closed by the shutter 7. The shutter 7 is attached to a part of the outer periphery of the rear magazine body 31 other than the cut part 33. The shutter 7 includes a body 71 which covers the opening 67 when the shutter is closed, and a connection part 72 which connects the rear end of the body 71 and the magazine body 31. The body 71 constitutes a part of the cylinder of which center axis seen in the front side corresponds to the center axis of the rear magazine 31.

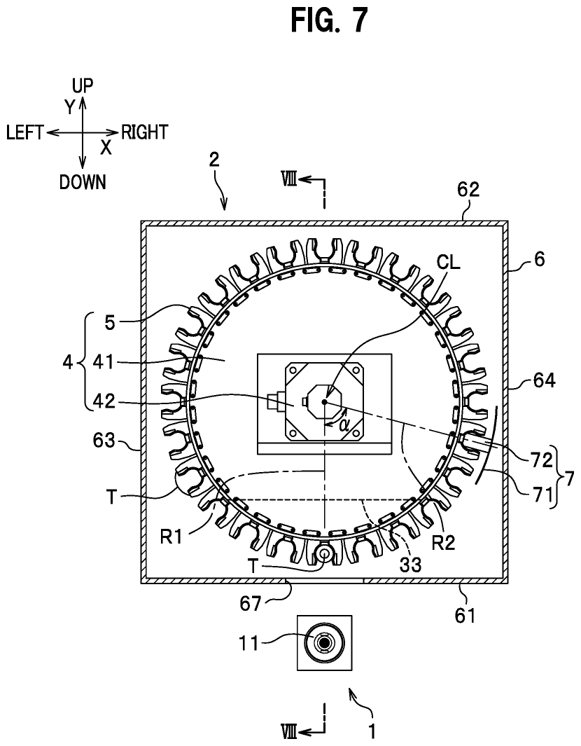

As shown in FIG. 6, the shutter 7 is provided in the vicinity of the cut part 33. More specifically, an angle α between the line R1 connecting the center axis CL of the rear magazine boy 31 with the center of the cut part 33 and the line R2 connecting the center axis CL with the center of the shutter 7 is set to be lower than 90 degree (see FIG. 7)

Next, the operation of the above machine tool 100 is described. It is assumed that various kinds of tools T are held in the tool holders 5 in the magazine bodies 31, 41. In the present embodiment, fourteen tools T are accommodated in the rear magazine 3 and twenty-four tools T are accommodated in the front magazine 4.

Firstly, a series of operation is described for attaching a tool T accommodated in the front magazine 4 to the main shaft 11 to which any of the tools T has not been attached yet. In the initial state, the shutter 7 of the rear magazine body 31 is arranged in the lower position and closes the opening 67 of the lower wall 61 as shown in FIGS. 3 to 5. At this time, the cut part 33 of the rear magazine body 31 is positioned in the left side of the tool changer 2 as shown in FIG. 6.

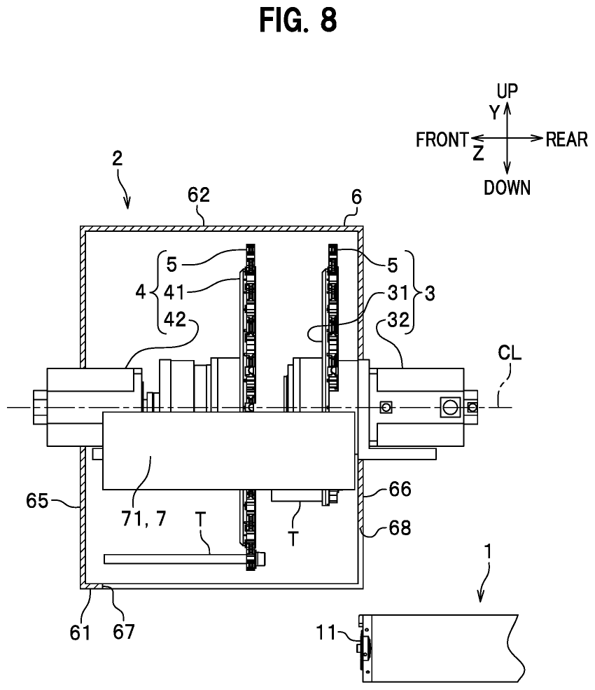

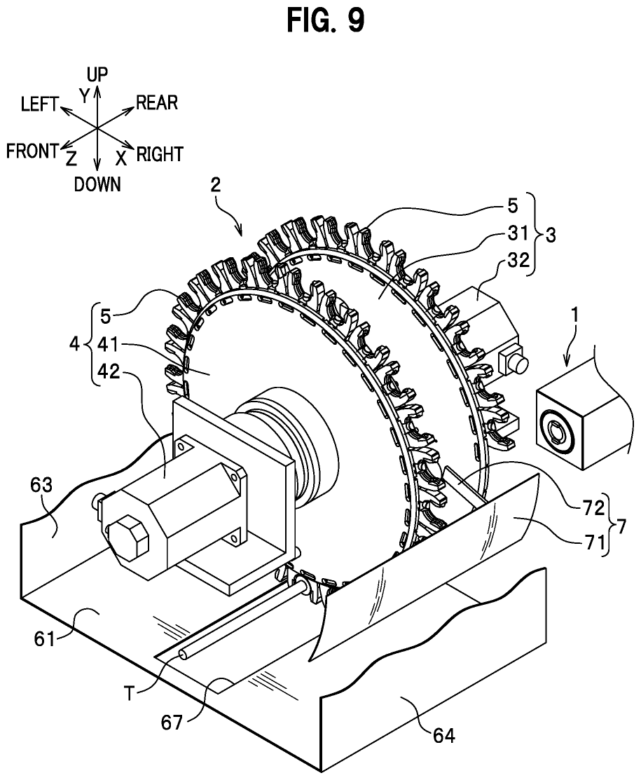

FIG. 7 is a cross sectional view of the machine tool 100 shown in FIG. 3 with the shutter 7 being opened. FIG. 8 is a cross sectional view of the machine tool 100 along the VIII-VIII line in FIG. 7. FIG. 4 shows the machine tool 100 with the shutter being opened. FIG. 9 is a perspective view of the machine tool 100 with the shutter being opened.

When the tool T accommodated in the front magazine 4 is going to be attached to the main shaft 11, the magazine body 31 of the rear magazine 3 is rotated such that the cut part 33 comes to the lower side of the tool changer 2 as shown in FIGS. 7 to 9. At this time, the shutter 7 comes to the right side of the tool changer 2 and opens the opening 67 of the lower wall 61. The main shaft unit 1 positioned in the standby position indicated in FIG. 8 is then raised so that the main shaft 11 comes to the same level as that of the tool T to be attached to the main shaft 11. In this state, the entire part of the distal end of the main shaft unit 1 can be seen through the cut part 33 when the rear magazine 3 is seen from the front side.

Next, the distal end of the main shaft unit 1 is moved frontward through the cut part 33 of the rear magazine 3. Then, the tool T accommodated in the front magazine 4 is attached to the distal end of the main shaft 11 and is clamped by the clamping mechanism (not shown). If the tool T in the front magazine 4 to be attached is not positioned at the lower end of the magazine body 41 in the front view, the magazine body 41 is rotated so as to move the tool T to be attached is positioned at the lower side of the magazine body 41.

Then, the main shaft unit 1 in which the tool T has been attached to the main shaft 11 is moved outward of the magazine body 41 in the radial direction (downward) and the tool T is detached from the tool holder 5. With this, the operation for attaching the tool T held in the front magazine 4 to the main shaft 11 to which the tool T has not been attached is completed. Then, the machine tool 100 processes the workpiece W with the tool T which is attached to the main shaft 11 by moving the main shaft unit 1.

An operation example is described below for exchanging the tool T which has been attached to the main shaft 11 and has been already used with another tool T which is to be used next. In this example, the another tool T to be attached is held in the tool holder 5 which is right-hand next to the tool holder 5 at the lower end of the magazine body 41 in the front view.

In this case, the main shaft unit 1 in which the tool T having been used is attached to the main shaft 11 is moved upward from the lower side to the empty tool holder 5 in which the tool T having been used was held at the first place so that the tool T is restored in the empty tool holder 5.

Clamping of the tool T attached to the main shaft 11 and having been used to the distal end of the main shaft 11 is unclamped by the clamp mechanism, and then, the main shaft unit 1 is moved rearward in a predetermined distance so that the tool T having been used is removed from the distal end of the main shaft 11.

Then, the magazine body 41 is rotated clockwise in the front view in an angle between the tool holders 5 which are next to each other. In this state, the distal end of the main shaft 11 is positioned right behind the another tool T to be attached next and held in the tool holder 5 at the lower end of the magazine 41 in the front view.

Next, the main shaft unit 1 is moved frontward so that the another tool T to be attached next is attached to the distal end of the main shaft 11. The another tool T is then clamped to the distal end of the main shaft 11 by the clamp mechanism (not shown).

Then, the main shaft unit 1 in which the another tool T is attached to the main shaft 11 is moved outward (downward) of the magazine body 41 in the radial direction of the magazine body 41 so that the another tool T is detached from the tool holder 5. With this, the operation is completed for exchanging the tool T attached to the main shaft 11 and having been used with the another tool T to be used next.

As described above, the tool changer 2 according to the present embodiment exchanges a tool T attached to the main shaft 11 of the machine tool 100 with another tool T. The tool changer 2 includes a first magazine 4 which is capable of accommodating tools T and a second magazine 3 which is capable of accommodating tools T, and a lower wall 61 which functions as a partition wall. The second magazine 3 is arranged rear to the first magazine 4 in line. The lower wall 61 partitions a first area A1 where the magazines 3,4 are provided and a second area A2 where the workpiece W is processed with the tool T attached to the main shaft 11. The lower wall 61 includes an opening 67 which communicates the first area A1 with the second area A2. The magazines 3, 4 respectively includes magazine bodies 31, 41 rotatable about the center axis CL which is parallel to the main shaft 11 in its axial direction and a plurality of tool holders 5 provided to the magazine bodies 31, 41. The magazine body 31 in the second magazine 3 includes a cut part 33 which is formed by cutting a part of the outer periphery of the magazine body 31. The tool holders 5 are provided to a part of the outer periphery of the magazine body 31 other than the cut part 33. A shutter 7 for opening or closing the opening 67 is attached to a part of the outer periphery of the magazine body 31 of the second magazine 3 other than the cut part 33. When a tool T accommodated in the first magazine 4 is to be attached to the main shaft 11, the magazine body 41 is rotated so as to move a tool holder which holds the tool T to be attached to an exchanging position (the lower side). When the tool T attached to the main shaft 11 is going to be restored in the first magazine 4, the magazine body 41 is rotated so as to move an empty tool holder 5 which is to hold the tool T to the exchanging position (the lower side). At this time, the magazine body 31 of the second magazine 3 is rotated to move the cut part 33 to the exchanging position (the lower side). With this rotation the shutter 7 is also moved to open the opening 67 of the lower wall 61. Thus, the cut part 33 of the magazine body 31 of the second magazine 3 and the opening 67 of the lower wall 61 functions as an escape structure for the main shaft 11. Therefore, the main shaft 11 is able to come close to or move away from the first magazine 4 without being interfered with the second magazine 3, whereby the tool exchange using the first magazine 4 is not prevented.

Further, the present invention makes it possible to prevent the chips of the workpiece from being scattered to the side of the magazines 3, 4 since the workpiece W is processed with the shutter 7 closing the opening 67 of the lower wall 61. It is arbitral whether to rotate the magazine body 41 of the first magazine 4 when the workpiece W is being processed. The magazine body 41 of the first magazine 4 may be rotated to prepare for the next step with the shutter 7 closing the opening 67.

When only two magazines 3, 4 are provided, there is no magazine rear to the rear magazine 3. When the rear magazine 3 is rotated so as to move the tool holder 5 holding the tool T to be attached next or the empty tool holder 5 which is to hold the tool T to the exchanging position (the lower side) the shutter 7 opens the opening 67. Thus, the tool exchange using the rear magazine 3 is able to be performed without anything interfering with the main shaft 11. At this time, it is arbitral whether to rotate the magazine body 41 of the first magazine 4. The magazine body 41 may be rotated to prepare for the next step while the tool T is exchanged using the rear magazine 3.

As described above, when the cut part 33 in the second magazine 3 is positioned in the bottom side, the shutter 7 attached to the part of the magazine body 31 other than the cut part 33 opens the opening 67 in the present embodiment. Thus, it is possible to efficiently exchange the tool T without anything interfering with the main shaft 11 regardless of whether any one of the plurality of magazines 3, 4 is used. Further, as the plurality of magazines 3, 4 is arranged in line in the present embodiment, it is possible to accommodate many tools T with avoiding the diameters of the magazine bodies 31, 41 from being made larger. Accordingly, the present embodiment provides a down-sized tool changer 2 which is capable of accommodating many tools T to be attached to the main shaft 11 and still is efficient in exchanging a tool T.

Further, in the present embodiment, an angle α between the line R1 connecting the center axis CL of the rear magazine boy 31 with the center of the cut part 33 and the line R2 connecting the center axis CL with the center of the shutter 7 is set to be lower than 90 degree. When the main shaft 11 is moved to take a tool T accommodated in the first magazine 4 from the state where the shutter 7 is positioned in the lower side and closes the opening 67, the cut part 33 needs to be positioned at the lower side. In this case, since the cut part 33 is arranged close to the shutter 7 according to the above structure, it is possible to reduce the time required for rotating the rear magazine body 31 to move the cut part 33 to the lower side. This makes it possible to shorten a rotation time of the magazine 3, enhancing the productivity of the machine tool 100.

Further, in the present embodiment, the plurality of magazine bodies 31, 41 is arranged in such a manner that their center axes are on the same straight line, and the diameters of circumcircles of the magazine bodies 31, 41 are equal. With this configuration, the plurality of magazines 3, 4 is allowed to accommodate more tools with the minimum space.

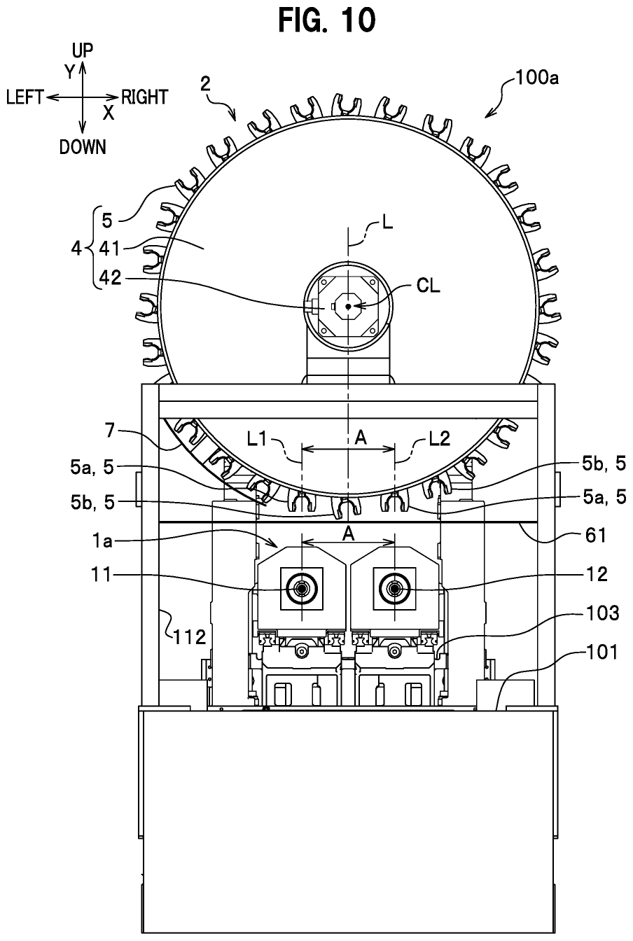

FIG. 10 is a front view of a machine tool 100 a including a tool changer 2 according to another embodiment of the present invention. In the another embodiment, a difference from the embodiment shown in FIGS. 1 to 9 is described in detail, and explanation for the features common in the another embodiment and the embodiment shown in FIGS. 1 to 9 is omitted. For the convenience of the explanation, a tool T (see FIG. 1, for example) is omitted in FIG. 10.

As shown in FIG. 10, the main shaft unit 1a of the machine tool 100 a includes two main shafts 11, 12 which are arranged with a distance A in between in a front view. A plurality of tool holders 5 includes a plurality of pairs of tool holders 5, 5, each being arranged with the same distance A in between as the distance A between the main shafts 11, 12 in the front view. The center lines L1, L2 of the pair of tool holders 5, 5 are parallel to the line L which connects the center axes CL of the magazine bodies 31, 41 with the center of the pair of the tool holders 5, 5 in its arranged direction in the front view. Further, one tool holder 5b of another pair of tool holders 5b, 5b is arranged in between the pair of tool holders 5a, 5a.

In this configuration, the center lines L1, L2 of the pair of tool holders 5, 5 are parallel to the line L without extending radially outside about the center axis CL. Thus, two tools T is able to be restored in or detached from the pair of tool holders 5, 5 at once by moving the main shaft unit 1 a (the main shaft 11, 12) in the up-down direction. Therefore, in this another embodiment, two tools T attached to the two main shafts 11, 12 are able to be exchanged at once.

Further, the two main shafts 11, 12 is provided in the machine tool 100a, and the pairs of tool holders 5, 5 are provided to the magazine bodies 31, 41 respectively in correspondence with the two main shafts 11, 12 in FIG. 10, however, the configuration is not limited to the one described above. For example, three main shafts may be arranged in the tool machine and a plurality of sets of three tool holders may be provided in the magazine bodies 31, 41.

Two embodiments of the present invention have been described as above, however, the present invention is not limited to the two embodiment described as above. The present invention may be implemented by combining or selecting the features described in the two embodiments or may be modified as appropriate in various forms without departing from the gist or main features of the present invention

For example, the tool changer 2 includes two magazines 3, 4 in the two embodiments described above, however, the present invention is not limited to this, and the tool changer 2 may include more than two magazines. If more than two magazines are provided and there is another magazine rear to the magazine which is in use for exchanging a tool, the cut part of the magazine body of the another magazine is placed in the exchanging position (the lower side) when the tool T is exchanged. With this configuration, the operation of exchanging the tool T is not interfered. Further, the magazine bodies 31, 41 are formed to be disciform in the two embodiments described above, however, the shapes of the magazine bodies 31, 41 are not limited to this and may be a multangular shape such as a hexagon. The plurality of magazine bodies 31, 41 are formed to be in the same shape in the front view except that the magazine body 31 includes the cut part 33 in the two embodiments described above. However, the shape of the magazine bodies 31, 41 are not limited to this, and the shapes or sizes of the magazine bodies 31, 41 may be different from each other. The body 71 of the shutter 7 is not limited to the disciform and may be a flat plate form. The body 71 of the shutter 7 may include an end plate extending from the rear end of the body 71 toward the center axis CL of the magazine body 31 (i.e. in the radially inner side). Thus, the entire shape of the shutter 7 may be L-shaped. In this structure, the shutter 7 is able to cover the openings 67, 68 in its closing state.

The machine tool 100, 100a is a horizontal machine tool in the two embodiment described as above, however, the machine tool according to the present invention is not limited to this and may be a vertical machine tool in which the main shaft is vertically arranged. In this case, the tool changer 2 should include a plurality of magazines arranged in the up-down direction. The work support unit 104 may be movably provided in both directions of the Z axis direction (the front-rear direction) and the X axis direction (the left and right direction) or in one of the directions of the Z and X axes directions.

What is claimed is:

1. A tool changer for a machine tool for exchanging a tool attached to a main shaft of the machine tool, comprising:
a first magazine which is capable of accommodating the tool;
a second magazine which is capable of accommodating the tool, wherein the second magazine is arranged rear to the first magazine when a distal end side of the main shaft is regarded as a front side and a base end side of the main shaft is regarded as a rear side;
a partition wall which partitions a first area where the first magazine and the second magazine are provided and a second area where a workpiece is processed with the tool attached to the main shaft, wherein
the partition wall includes an opening which communicates the first area with the second area;
the first magazine and the second magazine each includes
a magazine body rotatable about a center axis of the magazine body, the center axis being parallel to an axial direction of the main shaft; and
a plurality of tool holders provided to the magazine body, wherein the magazine body of the second magazine includes a cut part which is formed by cutting a part of an outer periphery of the magazine body, wherein
the plurality of the tool holders is provided to a part of the outer periphery of the magazine body of the second magazine other than the cut part; wherein
a shutter for opening or closing the opening is provided to a part of the outer periphery of the magazine body of the second magazine other than the cut part.

2. The tool changer according to claim 1, wherein an angle between a line connecting the center axis of the magazine body of the second magazine with a center of the cut part in a front view and a line connecting the center axis of the magazine body of the second magazine with a center of the shutter in the front view is set to be lower than 90 degrees.

3. The tool changer according to claim 1, wherein the magazine bodies of the first and second magazines are arranged in such a manner that their center axes of the magazine bodies exist on a straight line, and diameters of circumcircles of the magazine bodies are equal.

4. The tool changer according to claim 2, wherein the magazine bodies of the first and second magazines are arranged in such a manner that their center axes of the magazine bodies exist on a straight line, and diameters of circumcircles of the magazine bodies are equal.

5. The tool changer according to claim 1, wherein a plurality of main shafts is provided with a predetermined space between each of the plurality of main shafts in a front view,
the plurality of tool holders includes a plurality of sets of tool holders, each set consisting of a number of tool holders which is the same as a number of the plurality of the main shafts, and wherein
the tool holders in the each set are arranged with a distance in between which is the same as the distance between the each of the plurality of main shafts in the front view;
each of the tool holders in the each set includes a center line which is parallel to a line connecting a center of the magazine body with a center of the tool holders in the each set in an arranging direction of the tool holders in the each set in the front view, and
between the tool holders next to each other in a predetermined set is arranged one of the tool holders in a set adjacent to the predetermined set.

6. A machine tool which includes the tool changer according to claim 1.

7. A machine tool which includes the tool changer according to claim 2.

8. A machine tool which includes the tool changer according to claim 3.

9. A machine tool which includes the tool changer according to claim 4.

10. A machine tool which includes the tool changer according to claim 5.
